(19) United States
(12) Patent Application Publication
(10) Pub. No.: US 2018/0331841 A1
(43) Pub. Date: Nov. 15, 2018

(54) SYSTEMS AND METHODS FOR BANDWIDTH OPTIMIZATION DURING MULTI-USER MEETINGS THAT USE VIRTUAL ENVIRONMENTS

(71) Applicant: Tsunami VR, Inc., Del Mar, CA (US)

(72) Inventors: David ROSS, San Diego, CA (US); Beth BREWER, Escondido, CA (US)

(21) Appl. No.: 15/975,043

(22) Filed: May 9, 2018

Related U.S. Application Data
(60) Provisional application No. 62/505,828, filed on May 12, 2017.

(51) Int. Cl. H04L 12/18; H04L 29/06; H04L 12/24

(52) U.S. Cl. CPC H04L 12/1827; H04L 41/0896; H04L 67/38; H04L 12/1822

(57) ABSTRACT

Bandwidth optimization during multi-user meetings that use virtual environments displayed on screens of virtual reality, augmented reality or other user devices. Particular approaches for bandwidth optimization during multi-user meetings that use virtual environments generate a virtual environment for use by a first user, a second user, and optionally other users, determine that the first user is permitted to engage in one or more types of action within the virtual environment, determine that a second user is not permitted to engage in the one or more types of action within the virtual environment, permit the first user to engage in the one or more types of action within the virtual environment, and prohibit the second user from engaging in the one or more types of action within the virtual environment.

### RELATED APPLICATIONS

This application relates to the following related application(s): U.S. Pat. Appl. No. 62/505,828, filed May 12, 2017, entitled BANDWIDTH OPTIMIZATIONS FOR MULTI-USER, VIRTUAL REALITY AND AUGMENTED REALITY MEETINGS. The content of each of the related application(s) is hereby incorporated by reference herein in its entirety.

### TECHNICAL FIELD

This disclosure relates to virtual reality (VR), augmented reality (AR), and mixed reality (MR) technologies.

### BRIEF DESCRIPTION OF THE DRAWINGS

FIG. 1A and FIG. 1B depict aspects of a system on which different embodiments are implemented for bandwidth optimization during multi-user meetings that use virtual environments displayed on screens of virtual reality, augmented reality or other user devices.

FIG. 2 depicts a process for bandwidth optimization during multi-user meetings that use virtual environments displayed on screens of virtual reality, augmented reality or other user devices.

FIG. 3 illustrates embodiments for having active participants and passive observers.

### DETAILED DESCRIPTION

This disclosure relates to different approaches for bandwidth optimization during multi-user meetings that use virtual environments displayed on screens of virtual reality, augmented reality or other user devices.

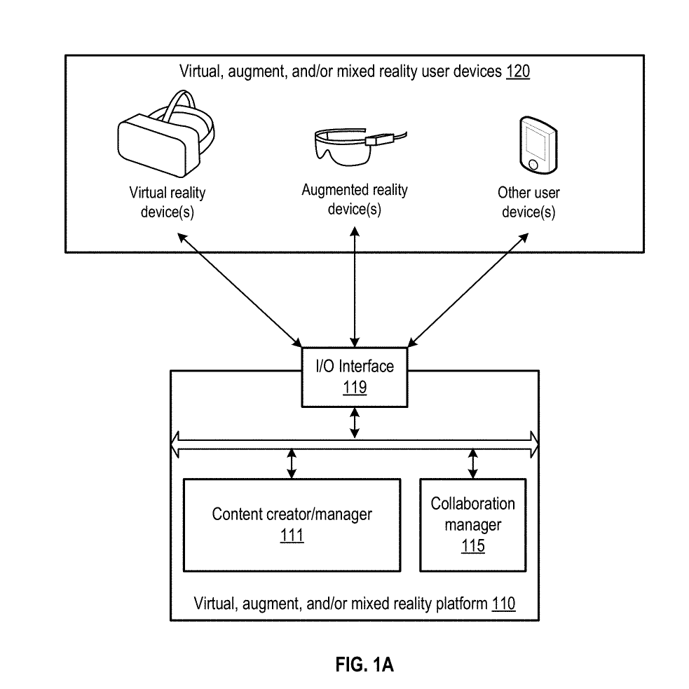

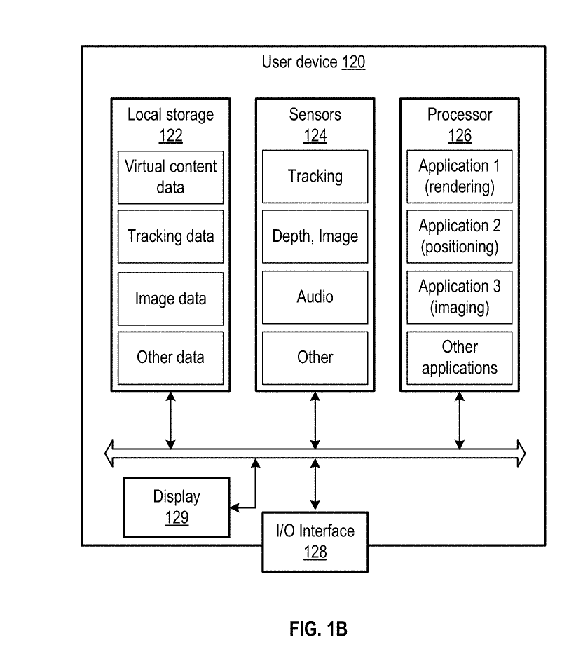

FIG. 1A and FIG. 1B depict aspects of a system on which different embodiments are implemented for bandwidth optimization during multi-user meetings that use virtual environments displayed on screens of virtual reality, augmented reality or other user devices. The system includes a virtual, augmented, and/or mixed reality platform 110 (e.g., including one or more servers) that is communicatively coupled to any number of virtual, augmented, and/or mixed reality user devices 120 such that data can be transferred between the platform 110 and each of the user devices 120 as required for implementing the functionality described in this disclosure. General functional details about the platform 110 and the user devices 120 are discussed below before particular functions for bandwidth optimization during multi-user meetings that use virtual environments displayed on screens of virtual reality, augmented reality or other user devices are discussed.

As shown in FIG. 1A, the platform 110 includes different architectural features, including a content creator/manager 111, a collaboration manager 115, and an input/output (I/O) interface 119. The content creator/manager 111 creates and stores visual representations of things as virtual content that can be displayed by a user device 120 to appear within a virtual or physical environment. Examples of virtual content include: virtual objects, virtual environments, avatars, video, images, text, audio, or other presentable data. The collaboration manager 115 provides virtual content to different user devices 120, and tracks poses (e.g., positions and orientations) of virtual content and of user devices as is known in the art (e.g., in mappings of environments, or other approaches). The I/O interface 119 sends or receives data between the platform 110 and each of the user devices 120.

Each of the user devices 120 include different architectural features, and may include the features shown in FIG. 1B, including a local storage component 122, sensors 124, processor(s) 126, an input/output (I/O) interface 128, and a display 129. The local storage component 122 stores content received from the platform 110 through the I/O interface 128, as well as information collected by the sensors 124. The sensors 124 may include: inertial sensors that track movement and orientation (e.g., gyros, accelerometers and others known in the art); optical sensors used to track movement and orientation of user gestures; position-location or proximity sensors that track position in a physical environment (e.g., GNSS, WiFi, Bluetooth or NFC chips, or others known in the art); depth sensors; cameras or other image sensors that capture images of the physical environment or user gestures; audio sensors that capture sound (e.g., microphones); and/or other known sensor(s). It is noted that the sensors described herein are for illustration purposes only and the sensors 124 are thus not limited to the ones described. The processor 126 runs different applications needed to display any virtual content within a virtual or physical environment that is in view of a user operating the user device 120, including applications for: rendering virtual content; tracking the pose (e.g., position and orientation) and the field of view of the user device 120 (e.g., in a mapping of the environment if applicable to the user device 120) so as to determine what virtual content is to be rendered on a display (not shown) of the user device 120; capturing images of the environment using image sensors of the user device 120 (if applicable to the user device 120); and other functions. The I/O interface 128 manages transmissions of data between the user device 120 and the platform 110. The display 129 may include, for example, a touchscreen display configured to receive user input via a contact on the touchscreen display, a semi or fully transparent display, or a non-transparent display. In one example, the display 129 includes a screen or monitor configured to display images generated by the processor 126. In another example, the display 129 may be transparent or semi-opaque so that the user can see through the display 129.

Particular applications of the processor 126 may include: a communication application, a display application, and a gesture application. The communication application may be configured to communicate data from the user device 120 to the platform 110 or to receive data from the platform 110, may include modules that may be configured to send images and/or videos captured by a camera of the user device 120 from sensors 124, and may include modules that determine the geographic location and the orientation of the user device 120 (e.g., determined using GNSS, WiFi, Bluetooth, audio tone, light reading, an internal compass, an accelerometer, or other approaches). The display application may generate virtual content in the display 129, which may include a local rendering engine that generates a visualization of the virtual content. The gesture application identifies gestures made by the user (e.g., predefined motions of the user's arms or fingers, or predefined motions of the user device 120 (e.g., tilt, movements in particular directions, or others). Such gestures may be used to define interaction or manipulation of virtual content (e.g., moving, rotating, or changing the orientation of virtual content).

Examples of the user devices 120 include VR, AR, MR and general computing devices with displays, including: head-mounted displays; sensor-packed wearable devices with a display (e.g., glasses); mobile phones; tablets; or other computing devices that are suitable for carrying out the functionality described in this disclosure. Depending on implementation, the components shown in the user devices 120 can be distributed across different devices (e.g., a worn or held peripheral separate from a processor running a client application that is communicatively coupled to the peripheral).

Having discussed features of systems on which different embodiments may be implemented, attention is now drawn to different processes for bandwidth optimization during multi-user meetings that use virtual environments displayed on screens of virtual reality, augmented reality or other user devices.

### Bandwidth Optimization During Multi-User Meetings that Use Virtual Environments Displayed on Screens of Virtual Reality, Augmented Reality or Other User Devices

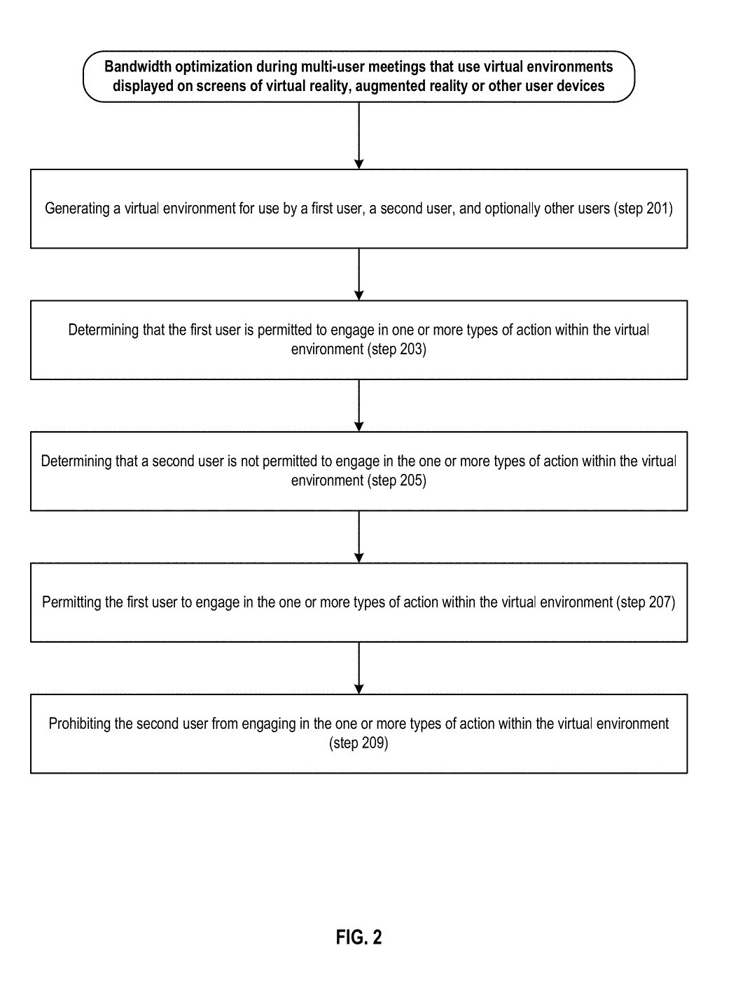

FIG. 2 depicts a method for bandwidth optimization during multi-user meetings that use virtual environments displayed on screens of virtual reality, augmented reality or other user devices. As shown, the method comprises: generating a virtual environment for use by a first user, a second user, and optionally other users (step 201); determining that the first user is permitted to engage in one or more types of action within the virtual environment (step 203); determining that a second user is not permitted to engage in the one or more types of action within the virtual environment (step 205); permitting the first user to engage in the one or more types of action within the virtual environment (step 207); and prohibiting the second user from engaging in the one or more types of action within the virtual environment (step 209).

By way of example, permitting a user to engage in a type of action during step 207 can be accomplished using different approaches. One approach includes providing an option to the user via a user device operated by the user that allows the user to perform the type of action (e.g., allowing the user to select any unoccupied position in the virtual environment before moving the user to the selected position, allowing the user to interact with virtual content other than viewing the virtual content, and/or allowing the user to transmit a type of communication). Another approach includes activating part of a user device operated by the user that initiates the type of action. Of course, any approach known in the art could be used.

By way of example, prohibiting a user from engaging in a type of action during step 209 can be accomplished using different approaches. One approach includes not providing an option to the user via a user device operated by the user that allows the user to perform the type of action (e.g., not allowing the user to select any unoccupied position in the virtual environment before moving the user to the selected position, not allowing the user to interact with virtual content other than viewing the virtual content, and/or not allowing the user to transmit a type of communication). Another approach includes deactivating part of a user device operated by the user that initiates the type of action. Of course, any approach known in the art could be used.

### Not Allowing Certain Users to Move Among Different Positions in the Virtual Environment

In one embodiment for not allowing certain users to move among different positions in the virtual environment, the one or more types of action includes moving to any position in the virtual environment, and the method comprises: determining a position in the virtual environment at which the second user is to be located; setting the position as the location of the second user in the virtual environment; providing a user device operated by the second user with images of the virtual environment that is in view from the position; and not allowing the second user to move from the position to any other position in the virtual environment. In one implementation of this embodiment, the types positions to which movement is allowed includes only positions that are not occupied by other users or virtual content. In another implementation of this embodiment, the types positions to which movement is allowed includes positions occupied by other users.

Only Allowing Certain Users to Move Among Predefined Positions in the Virtual Environment

In one embodiment for only allowing certain users to move among predefined positions in the virtual environment, the one or more types of action includes moving to any position in the virtual environment, and the method comprises: determining a first position from among a first set of one or more predefined positions in the virtual environment at which the second user is to be located; setting the first position as the location of the second user in the virtual environment during a first period of time; providing a user device operated by the second user with images of the virtual environment that is in view from the first position; allowing the second user to move from the first position to a second position in the first set of one or more predefined positions in the virtual environment; and not allowing the second user to move to any other position in the virtual environment that is not a position in the first set of predefined positions.

Determining which Positions are Included in the First Set of Predefined Positions

In one embodiment for determining which positions are included in the first set of predefined positions, the method comprises: receiving, from a user, a selection of a group of one or more positions in the virtual environment; including the selected group of positions as positions in the first set of one or more predefined positions; excluding, from the first set of one or more predefined positions, other positions in the virtual environment that were not selected by the user; and storing information about the first set of one or more predefined positions. By way of example, the information about the first set of one or more predefined positions may include coordinates of the positions in the virtual environment.

Moving a User to a New Predefined Position in the Virtual Environment

In one embodiment for moving a user to a new predefined position in the virtual environment, the one or more types of action includes moving to any of all positions in the virtual environment, and wherein the method comprises: determining that the first user moved from a first position to a second position; and in response to determining that the first user moved from the first position to the second position, moving the second user from a first predefined position to a second predefined position.

In one implementation of this embodiment, each nth predefined position is determined based on the nth position—e.g., the nth predefined position is within a predefined distance of or at a predefined location relative to the nth position, or the nth predefined position is selected by a first user (e.g., the first user or a different user) as the position of a second user who is not permitted to engage in the one or more types of action within the virtual environment (e.g., the second user) when the first user is at the nth position.

Limiting User Interaction with Virtual Content

In one embodiment for limiting user interaction with virtual content, the virtual environment contains virtual content, the one or more types of action includes interacting with the virtual content other than viewing the virtual content, and the method comprises, for each user in a second set of users that includes the second user: providing a user device operated by that user with images of virtual content; and prohibiting that user from interacting with the virtual content other than viewing the virtual content.

Examples of interaction other than viewing include moving the virtual content, modifying the virtual content, adding new content to the virtual content, annotating the virtual content, or other known interactions.

### Not Allowing Certain Users to Distribute Communication to Other Users, but Optionally Allowing Those Certain Users to Receive Communications from Other Users

In one embodiment for not allowing certain users to distribute communication to other users, but optionally allowing those certain users to receive communications from other users, the one or more types of action includes distributing a predefined type of communication data to other users, and the method comprises, for each user in a second set of users that includes the second user: prohibiting that user from distributing the predefined type of communication data to other users.

Examples of predefined types of communication data include: audio data, text data, video data, image data, or other known communication data.

### Determining the One or More Types of Action

In one embodiment for determining the one or more types of action, the one or more types of action are selected by an administrator of the meeting before the steps of (i) determining that the first user is permitted to engage in the one or more types of action and (iii) determining that a second user is not permitted to engage in the one or more types of action.

### Determining which Users are Permitted to Engage in the Type of Action Based on Maximum Number of Users Who are Permitted to Engage in the Type of Action

In one embodiment for determining which users are permitted to engage in the type of action based on maximum number of users who are permitted to engage in the type of action, the method comprises: determining a maximum number of users that are allowed to engage in the one or more types of action within the virtual environment, wherein determining that the first user is permitted to engage in the one or more types of action within the virtual environment comprises determining that a first number of users determined as being permitted to engage in the one or more types of action within the virtual environment at a first instance in time is less than the maximum number of users, and wherein determining that the second user is not permitted to engage in the one or more types of action within the virtual environment comprises determining that a second number of users determined as being permitted to engage in the one or more types of action within the virtual environment at a second instance in time after the first instance in time is not less than the maximum number of users.

Determining which Users are Permitted to Engage in the Type of Action Based on Identification of a User by an Administrator

In one embodiment for determining which users are permitted to engage in the type of action based on identification of a user by an administrator, wherein the method comprises: determining that the first user is permitted to engage in the one or more types of action within the virtual environment when the first user is identified by another user as being permitted to engage in the one or more types of action within the virtual environment; and determining that the second user is not permitted to engage in the one or more types of action within the virtual environment when the second user is not identified by another user as being permitted to engage in the one or more types of action within the virtual environment.

### Determining which Users are Permitted to Engage in the Type of Action Based on Status Value

In one embodiment for determining which users are permitted to engage in the type of action based on status value, the method comprises: determining that the first user is permitted to engage in the one or more types of action within the virtual environment when the first user has a first status value that matches a predefined status value; and determining that the second user is not permitted to engage in the one or more types of action within the virtual environment when the second user has a second status value that does not match the predefined status value.

Examples of status values include permission levels, organizational titles, types of invitations received from an administrator of a meeting that uses the virtual environment, qualifications, or other ways to separate different users. Predefined status values may already exist, or may be defined by an administrator of the meeting or, more generally, the virtual environment.

### Determining which Users are Permitted to Engage in the Type of Action Based on Capability of the User Device Operated by the User

In one embodiment for determining which users are permitted to engage in the type of action based on capability of the user device operated by the user, wherein the method comprises: determining that the first user is permitted to engage in the one or more types of action within the virtual environment when a first user device operated by the first user has a first capability that matches one or more predefined capabilities; and determining that the second user is not permitted to engage in the one or more types of action within the virtual environment when a second user device operated by the second user has a second capability that does not match the one or more predefined capabilities.

Examples of capabilities include: a connection speed of the user device, a battery level of the user device, a processing speed or processing capacity of the user device, a type of display of the user device (e.g., 3D screen that can display 3D images), a type of input of the user device (e.g., microphone, camera), a type of output of the user device (e.g., speaker, a screen), or other capability.

### Determining which Users are Permitted to Engage in the Type of Action Based on a Connection Speed of the User Device Operated by the User

In one embodiment for determining which users are permitted to engage in the type of action based on a connection speed of the user device operated by the user, the method comprises: determining that the first user is permitted to engage in the one or more types of action within the virtual environment when a first connection speed of a first user device operated by the first user matches or exceeds a predefined connection speed; and determining that the second user is not permitted to engage in the one or more types of action within the virtual environment when a second connection speed of a second user device operated by the second user does not match or exceed the predefined connection speed.

### The Types of Actions a User is Permitted to Engage in Change Over Time from Being Permitted to Prohibited

In one embodiment where the types of actions a user is permitted to engage in change over time from being permitted to prohibited, the steps of (i) determining that the first user is permitted to engage in the one or more types of action, (ii) determining that the second user is not permitted to engage in the one or more types of action, (iii) permitting the first user to engage in the one or more types of action, and (iv) prohibiting the second user from engaging in the one or more types of action occur during a first time period, and wherein the method comprises: determining, during a second time period, that the first user is not permitted to engage in the one or more types of action within the virtual environment; prohibiting, during the second time period, the first user from engaging in the one or more types of action within the virtual environment.

Different examples of determining, during the first time period, that the first user is permitted to engage in the one or more types of action within the virtual environment include: (i) the first user is identified by another user as being permitted to engage in the one or more types of action within the virtual environment, (ii) a status value of the first user matches a predefined status value, (iii) a user device operated by the first user has a capability that matches a predefined capability, or (iv) a connection speed of the user device operated by the first user matches or exceeds a predefined connection speed.

Different examples of determining, during the second time period, that the first user is not permitted to engage in the one or more types of action within the virtual environment include: (i) the first user is no longer identified by the other user as being permitted to engage in the one or more types of action within the virtual environment, (ii) a new status value of the first user does not match the predefined status value, (iii) the user device operated by the first user no longer has the capability that matches the predefined capability, or (iv) the connection speed of the user device operated by the first user no longer matches or exceeds the predefined connection speed.

### The Types of Actions a User is Permitted to Engage in Change Over Time from Being Prohibited to Permitted

In one embodiment where the types of actions a user is permitted to engage in change over time from being prohibited to permitted, the steps of (i) determining that the first user is permitted to engage in the one or more types of action, (ii) determining that a second user is not permitted to engage in the one or more types of action, (iii) permitting the first user to engage in the one or more types of action, and (iv) prohibiting the second user from engaging in the one or more types of action occur during a first time period, and wherein the method comprises: determining, during a second time period, that the second user is permitted to engage in the one or more types of action within the virtual environment; and permitting, during the second time period, the second user to engage in the one or more types of action within the virtual environment.

Different examples of determining, during the first time period, that the second user is not permitted to engage in the one or more types of action within the virtual environment include: (i) the second user is not identified by another user as being permitted to engage in the one or more types of action within the virtual environment, (ii) a status value of the second user does not match a predefined status value, (iii) a user device operated by the second user does not have a capability that matches a predefined capability, (iv) a connection speed of the user device operated by the second user does not match or exceed a predefined connection speed, or (v) no additional users are permitted to engage in the one or more types of action within the virtual environment when the first user is permitted to engage in the one or more types of action within the virtual environment.

Different examples of determining, during the second time period, that the second user is permitted to engage in the one or more types of action within the virtual environment include: (i) the second user is identified by the other user as being permitted to engage in the one or more types of action within the virtual environment, (ii) a new status value of the second user matches the predefined status value, (iii) the user device operated by the second user has the capability that matches the predefined capability, (iv) the connection speed of the user device operated by the second user matches or exceeds the predefined connection speed, or (v) the first user is no longer permitted to engage in the one or more types of action within the virtual environment.

### Exchanging Permitted and Prohibited Actions Among Users

In one embodiment where two users switch their permitted and prohibited action, (i) determining that the first user is permitted to engage in the one or more types of action, (ii) determining that a second user is not permitted to engage in the one or more types of action, (iii) permitting the first user to engage in the one or more types of action, and (iv) prohibiting the second user from engaging in the one or more types of action occur during a first time period, and wherein the method comprises: determining, during a second time period, that the second user is permitted to engage in the one or more types of action within the virtual environment; determining, during the second time period, that the first user is not permitted to engage in the one or more types of action within the virtual environment; permitting, during the second time period, the second user to engage in the one or more types of action within the virtual environment; and prohibiting, during the second time period, the first user from engaging in the one or more types of action within the virtual environment.

In one embodiment for exchanging permitted and prohibited actions among users—e.g., where the first user relinquishes his or her ability to engage in the one or more types of action within the virtual environment to the second user, after which the first user is no longer permitted to engage in the one or more types of action, and the second user is permitted to engage in the one or more types of action, the method comprises: receiving, during the second time period, a selection of the second user from the first user; and in response to receiving the selection of the second user during the second time period, determining that the first user is not permitted to engage in the one or more types of action within the virtual environment, and that the second user is permitted to engage in the one or more types of action within the virtual environment.

### Other Embodiments

When people meet in virtual space, the capacity of freely active users that can move around the space at will is limited by the bandwidth and processing power which is taken up by the function of the number of users, N, squared. The limit on the current typical internet bandwidth in the United States is about 15-20 freely active users per virtual meeting space as each of the users is receiving the vector data/and other data of all of the other users.

General definitions used in this section include the following:

Virtual Reality (“VR”) is generally defined as an artificially created environment generated with a computer, and experienced by the sensory stimulation (visually, audibly, . . . etc.) of a user.

Head Mounted Display (“HMD”) is a visual display mounted to a user's head.

Augmented Reality (“AR”) is generally defined as an environment that combines visual images (graphical, symbolic, alphnumerics, . . . etc.) with a user's real view.

Mixed Reality (“MR”) is generally defined as a combination of the real world, VR and AR.

There is a need for a system that allows for greater attendance of virtual meetings without creating the need for greater bandwidth.

The purpose of the embodiments of this section is to allow a very high number of users to be in the same virtual space at the same time.

The technology is a process or a software algorithm that applies rules and user choices so that more people can become immersed in the same live conference.

Given a hard limit of bandwidth and processing power, a very soft and flexible limit of active users can be adapted to a conference in virtual space so that many more participants, potentially even 1000s of users, can join the conference/presentation remotely.

Several layers of freedom are allocated to the freely active users that join the meeting which range from, complete freedom to move around the space to observing the meeting from a fixed location, in a listen-only, watch-only mode. Listen-only, watch-only participants are theoretically unlimited and could see all of the perspectives from each of the freely active meeting participants. Participants could also move between being active (High Individual Bandwidth) and passive (Shared bandwidth) during the meeting.

Many more users can attended and participate in a meeting with a very limited amount of bandwidth and computer resources.

Software, User Interfaces, and algorithms are put into practice that allow VR/AR meeting participants to dynamically move in and out of levels of activity and freedom to allow more meeting participants to view or participate in the meeting.

The Observer Platform(s) for passive meeting participants. Positioned with a view of the meeting and movable by the active participants so the passive viewers can see what the active participants want them to see. Optionally the passive viewers can choose the perspective of any of the active participants.

Optimization algorithm. Math formula used to manage users in a meeting as more and more people join. Variables, and behavior can be managed by an administrator. Example: All users after Nth user will be passive viewers.

A method for bandwidth optimization for multi-user, virtual reality (VR) meetings comprises: establishing a VR meeting; receiving at least one primary attendee at the VR meeting, wherein the at least one primary attendee is an active attendee; and receiving a plurality of secondary attendees at the VR meeting, wherein each of the plurality of secondary attendees is a passive attendee; wherein the VR movement of the least one primary attendee is unlimited within the confines of the VR meeting space; wherein the VR movement of each of the plurality of secondary attendees is limited to a predetermined number of VR positions within the VR meeting space that are controlled by the at least one primary attendee. In one embodiment, the plurality of secondary attendees occupy one of the two VR positions. In one embodiment, the method further comprises receiving a second primary attendee at the VR meeting, wherein the second primary attendee is an active attendee, and wherein the VR movement of the second primary attendee is unlimited within the confines of the VR meeting space. In one embodiment, each new attendee is a secondary attendee. In one embodiment, the plurality of secondary attendees is greater than ten secondary attendees. In one embodiment, the plurality of secondary attendees is greater than one hundred secondary attendees. In one embodiment, the plurality of secondary attendees is greater than one thousand secondary attendees. In one embodiment, the plurality of secondary attendees is greater than ten thousand secondary attendees. In one embodiment, each of the plurality of secondary attendees is in a listen only, watch only mode. In one embodiment, the method further comprises: receiving a plurality of primary attendees at the VR meeting, the plurality of primary attendees is less than ten primary attendees.

A system for bandwidth optimization for multi-user, virtual reality (VR) meetings comprises: a collaboration manager at a server; at least one primary attendee display device; a plurality of secondary attendee display devices; wherein the collaboration manager is configured to establish a VR meeting; wherein the collaboration manager is configured to receive at least one primary attendee at the VR meeting from the at least one primary attendee display device; wherein the at least one primary attendee is an active attendee; wherein the collaboration manager is configured to receive a plurality of secondary attendees at the VR meeting from the plurality of secondary attendee display devices; wherein each of the plurality of secondary attendees is a passive attendee; wherein the VR movement of the least one primary attendee is unlimited within the confines of the VR meeting space; wherein the VR movement of each of the plurality of secondary attendees is limited to a predetermined number of VR positions within the VR meeting space that are controlled by the at least one primary attendee. In one embodiment, the plurality of secondary attendees occupy one of the two VR positions. In one embodiment, the system further comprises: a second primary attendee display device, wherein the second primary attendee is an active attendee, and wherein the VR movement of the second primary attendee is unlimited within the confines of the VR meeting space. In one embodiment, the at least one primary attendee display device is a VR headset. In one embodiment, the plurality of secondary attendee display devices is greater than ten secondary attendees. In one embodiment, the plurality of secondary attendees is greater than one hundred secondary attendees. In one embodiment, the plurality of secondary attendee display devices is greater than one thousand secondary attendees. In one embodiment, the plurality of secondary attendee display devices is greater than ten thousand secondary attendees. In one embodiment, each of the plurality of secondary attendee display devices is in a listen only, watch only mode. In one embodiment, the system further comprises: a plurality of primary attendee display devices, the plurality of primary attendee display devices is less than ten. In one embodiment, each of the plurality of secondary attendee display devices is a device selected from the group comprising a desktop computer, a laptop computer, a mobile phone, an AR headset, a MR headset, and a VR headset. In one embodiment, an action of each of the plurality of secondary attendees requires at least 3 kbps.

A method for bandwidth optimization for multi-user, virtual reality (VR) meetings comprises: establishing a VR meeting at a collaboration manager at a server; receiving a plurality of primary attendees at the VR meeting, wherein the each of the plurality of primary attendees is an active attendee; and receiving a plurality of secondary attendees at the VR meeting, wherein each of the plurality of secondary attendees is a passive attendee; wherein the VR movement each of the plurality of primary attendees is unlimited within the confines of the VR meeting space; wherein the VR movement of each of the plurality of secondary attendees is limited to a predetermined number of VR positions within the VR meeting space that are controlled by the plurality of primary attendees. In one embodiment, the plurality of secondary attendees occupy one of the two VR positions. In one embodiment, each of the plurality of secondary attendees occupies a single VR person in the VR meeting space. In one embodiment, each new attendee is a secondary attendee. In one embodiment, the plurality of secondary attendees is greater than ten secondary attendees. In one embodiment, the plurality of secondary attendees is greater than one hundred secondary attendees. In one embodiment, the plurality of secondary attendees is greater than one thousand secondary attendees. In one embodiment, the plurality of secondary attendees is greater than ten thousand secondary attendees. In one embodiment, each of the plurality of secondary attendees is in a listen only, watch only mode.

A method for bandwidth optimization for multi-user, virtual reality (VR) meetings comprises: establishing a VR meeting; receiving at least one primary attendee at the VR meeting; and receiving a plurality of secondary attendees at the VR meeting; wherein the VR movement of the least one primary attendee is unlimited within the confines of the VR meeting space; wherein the VR movement of each of the plurality of secondary attendees is limited to a predetermined number of VR positions within the VR meeting space. In one embodiment, the plurality of secondary attendees occupy one of two VR positions. In one embodiment, the method comprises: receiving a second primary attendee at the VR meeting, and wherein the VR movement of the second primary attendee is unlimited within the confines of the VR meeting space. In one embodiment, each new attendee is a secondary attendee. In one embodiment, the plurality of secondary attendees is greater than ten secondary attendees. In one embodiment, the plurality of secondary attendees is greater than one hundred secondary attendees. In one embodiment, the plurality of secondary attendees is greater than one thousand secondary attendees. In one embodiment, the plurality of secondary attendees is greater than ten thousand secondary attendees. In one embodiment, each of the plurality of secondary attendees is in a listen only, watch only mode. In one embodiment, the method comprises: receiving a plurality of primary attendees at the VR meeting, the plurality of primary attendees is less than ten primary attendees.

A system for bandwidth optimization for multi-user, virtual reality (VR) meetings comprises: a collaboration manager at a server; at least one primary attendee display device; a plurality of secondary attendee display devices; wherein the collaboration manager is configured to establish a VR meeting; wherein the collaboration manager is configured to receive at least one primary attendee at the VR meeting from the at least one primary attendee display device; wherein the collaboration manager is configured to receive a plurality of secondary attendees at the VR meeting from the plurality of secondary attendee display devices; wherein the VR movement of the least one primary attendee is unlimited within the confines of the VR meeting space; wherein the VR movement of each of the plurality of secondary attendees is limited to a predetermined number of VR positions within the VR meeting space.

A method for bandwidth optimization for multi-user, augmented reality (AR) meetings, the method comprising: establishing an AR meeting; receiving at least one primary attendee at the AR meeting, wherein the at least one primary attendee is an active attendee; and receiving a plurality of secondary attendees at the AR meeting, wherein each of the plurality of secondary attendees is a passive attendee; wherein the AR movement of the least one primary attendee is unlimited within the confines of the AR meeting space; wherein the AR movement of each of the plurality of secondary attendees is limited to a predetermined number of AR positions within the AR meeting space that are controlled by the at least one primary attendee. In one embodiment, the plurality of secondary attendees occupy one of the two AR positions. In one embodiment, the method comprises: receiving a second primary attendee at the AR meeting, wherein the second primary attendee is an active attendee, and wherein the AR movement of the second primary attendee is unlimited within the confines of the AR meeting space. In one embodiment, the plurality of secondary attendees is greater than one thousand secondary attendees. In one embodiment, the method comprises: receiving a plurality of primary attendees at the AR meeting, the plurality of primary attendees is less than ten primary attendees.

A system for bandwidth optimization for multi-user, augmented reality (AR) meetings comprises: a collaboration manager at a server; at least one primary attendee display device; a plurality of secondary attendee display devices; wherein the collaboration manager is configured to establish an AR meeting; wherein the collaboration manager is configured to receive at least one primary attendee at the AR meeting from the at least one primary attendee display device; wherein the collaboration manager is configured to receive a plurality of secondary attendees at the AR meeting from the plurality of secondary attendee display devices; wherein the AR movement of the least one primary attendee is unlimited within the confines of the AR meeting space; wherein the AR movement of each of the plurality of secondary attendees is limited to a predetermined number of AR positions within the AR meeting space.

A system for bandwidth optimization for multi-user, mixed reality (MR) meetings, the system comprising: a collaboration manager at a server; at least one primary attendee display device; a plurality of secondary attendee display devices; wherein the collaboration manager is configured to establish a MR meeting; wherein the collaboration manager is configured to receive at least one primary attendee at the MR meeting from the at least one primary attendee display device; wherein the collaboration manager is configured to receive a plurality of secondary attendees at the MR meeting from the plurality of secondary attendee display devices; wherein the MR movement of the least one primary attendee is unlimited within the confines of the MR meeting space; wherein the MR movement of each of the plurality of secondary attendees is limited to a predetermined number of MR positions within the MR meeting space.

A method for bandwidth optimization for multi-user, mixed reality (MR) meetings, the method comprising: establishing a MR meeting; receiving at least one primary attendee at the MR meeting, wherein the at least one primary attendee is an active attendee; and receiving a plurality of secondary attendees at the MR meeting, wherein each of the plurality of secondary attendees is a passive attendee; wherein the MR movement of the least one primary attendee is unlimited within the confines of the MR meeting space; wherein the MR movement of each of the plurality of secondary attendees is limited to a predetermined number of MR positions within the MR meeting space that are controlled by the at least one primary attendee. In one embodiment, the plurality of secondary attendees occupy one of the two MR positions. In one embodiment, the method further comprises receiving a second primary attendee at the MR meeting, wherein the second primary attendee is an active attendee, and wherein the MR movement of the second primary attendee is unlimited within the confines of the MR meeting space. In one embodiment, the plurality of secondary attendees is greater than one thousand secondary attendees. In one embodiment, the method further comprises receiving a plurality of primary attendees at the MR meeting, the plurality of primary attendees is less than ten primary attendees.

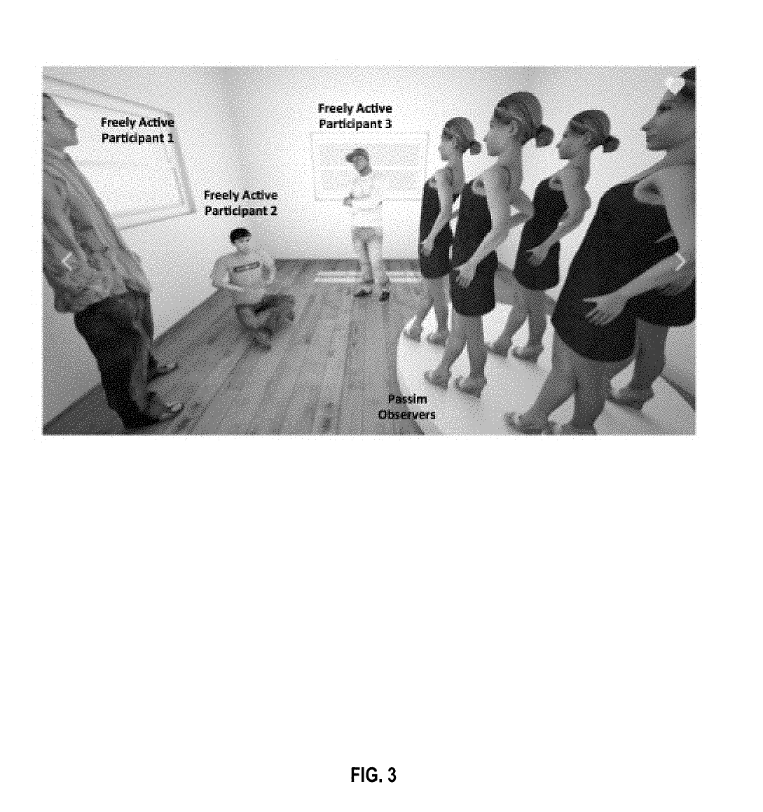

FIG. 3 illustrates embodiments for having active participants and passive observers.

The user interface elements include the capacity viewer and mode changer.

The human eye's performance. 150 pixels per degree (foveal vision). Field of view Horizontal: 145 degrees per eye Vertical 135 degrees. Processing rate: 150 frames per second Stereoscopic vision Color depth: 10 million? (Let's decide on 32 bits per pixel)=470 megapixels per eye, assuming full resolution across entire FOV (33 megapixels for practical focus areas) Human vision, full sphere: 50 Gbits/sec. Typical HD video: 4 Mbits/sec and we would need >10,000 times the bandwidth. HDMI can go to 10 Mbps.

For each selected environment there are configuration parameters associated with the environment that the author must select, for example, number of virtual or physical screens, size/resolution of each screen, and layout of the screens (e.g. carousel, matrix, horizontally spaced, etc). If the author is not aware of the setup of the physical space, the author can defer this configuration until the actual meeting occurs and use the Narrator Controls to set up the meeting and content in real-time.

The following is related to a VR meeting. Once the environment has been identified, the author selects the AR/VR assets that are to be displayed. For each AR/VR asset the author defines the order in which the assets are displayed. The assets can be displayed simultaneously or serially in a timed sequence. The author uses the AR/VR assets and the display timeline to tell a “story” about the product. In addition to the timing in which AR/VR assets are displayed, the author can also utilize techniques to draw the audience's attention to a portion of the presentation. For example, the author may decide to make an AR/VR asset in the story enlarge and/or be spotlighted when the “story” is describing the asset and then move to the background and/or darken when the topic has moved on to another asset.

When the author has finished building the story, the author can play a preview of the story. The preview playout of the story as the author has defined but the resolution and quality of the AR/VR assets are reduced to eliminate the need for the author to view the preview using AR/VR headsets. It is assumed that the author is accessing the story builder via a web interface, so therefore the preview quality should be targeted at the standards for common web browsers.

After the meeting organizer has provided all the necessary information for the meeting, the Collaboration Manager sends out an email to each invitee. The email is an invite to participate in the meeting and also includes information on how to download any drivers needed for the meeting (if applicable). The email may also include a preload of the meeting material so that the participant is prepared to join the meeting as soon as the meeting starts.

The Collaboration Manager also sends out reminders prior to the meeting when configured to do so. Both the meeting organizer or the meeting invitee can request meeting reminders. A meeting reminder is an email that includes the meeting details as well as links to any drivers needed for participation in the meeting.

Prior to the meeting start, the user needs to select the display device the user will use to participate in the meeting. The user can use the links in the meeting invitation to download any necessary drivers and preloaded data to the display device. The preloaded data is used to ensure there is little to no delay experienced at meeting start. The preloaded data may be the initial meeting environment without any of the organization's AR/VR assets included. The user can view the preloaded data in the display device, but may not alter or copy it.

At meeting start time each meeting participant can use a link provided in the meeting invite or reminder to join the meeting. Within 1 minute after the user clicks the link to join the meeting, the user should start seeing the meeting content (including the virtual environment) in the display device of the user's choice. This assumes the user has previously downloaded any required drivers and preloaded data referenced in the meeting invitation.

Each time a meeting participant joins the meeting, the story Narrator (i.e. person giving the presentation) gets a notification that a meeting participant has joined. The notification includes information about the display device the meeting participant is using. The story Narrator can use the Story Narrator Control tool to view each meeting participant's display device and control the content on the device. The Story Narrator Control tool allows the Story Narrator to.

View all active (registered) meeting participants

View all meeting participant's display devices

View the content the meeting participant is viewing

View metrics (e.g. dwell time) on the participant's viewing of the content

Change the content on the participant's device

Enable and disable the participant's ability to fast forward or rewind the content

Each meeting participant experiences the story previously prepared for the meeting. The story may include audio from the presenter of the sales material (aka meeting coordinator) and pauses for Q&A sessions. Each meeting participant is provided with a menu of controls for the meeting. The menu includes options for actions based on the privileges established by the Meeting Coordinator defined when the meeting was planned or the Story Narrator at any time during the meeting. If the meeting participant is allowed to ask questions, the menu includes an option to request permission to speak. If the meeting participant is allowed to pause/resume the story, the menu includes an option to request to pause the story and once paused, the resume option appears. If the meeting participant is allowed to inject content into the meeting, the menu includes an option to request to inject content.

The meeting participant can also be allowed to fast forward and rewind content on the participant's own display device. This privilege is granted (and can be revoked) by the Story Narrator during the meeting.

After an AR story has been created, a member of the maintenance organization that is responsible for the “tools” used by the service technicians can use the Collaboration Manager Front-End to prepare the AR glasses to play the story. The member responsible for preparing the tools is referred to as the tools coordinator.

In the AR experience scenario, the tools coordinator does not need to establish a meeting and identify attendees using the Collaboration Manager Front-End, but does need to use the other features provided by the Collaboration Manager Front-End. The tools coordinator needs a link to any drivers necessary to playout the story and needs to download the story to each of the AR devices. The tools coordinator also needs to establish a relationship between the Collaboration Manager and the AR devices. The relationship is used to communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

Ideally Tsunami would build a function in the VR headset device driver to “scan” the live data feeds for any alarms and other indications of a fault. When an alarm or fault is found, the driver software would change the data feed presentation in order to alert the support team member that is monitoring the virtual NOC.

The support team member also needs to establish a relationship between the Collaboration Manager and the VR headsets. The relationship is used to connect the live data feeds that are to be displayed on the Virtual NOCC to the VR headsets, communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

The story and its associated access rights are stored under the author's account in Content Management System. The Content Management System is tasked with protecting the story from unauthorized access. In the virtual NOCC scenario, the support team member does not need to establish a meeting and identify attendees using the Collaboration Manager Front-End, but does need to use the other features provided by the Collaboration Manager Front-End. The support team member needs a link to any drivers necessary to playout the story and needs to download the story to each of the VR head.

The Asset Generator is a set of tools that allows a Tsunami artist to take raw data as input and create a visual representation of the data that can be displayed in a VR or AR environment. The raw data can be virtually any type of input from: 3D drawings to CAD files, 2D images to power point files, user analytics to real time stock quotes. The Artist decides if all or portions of the data should be used and how the data should be represented. The i Artist is empowered by the tool set offered in the Asset Generator.

The Content Manager is responsible for the storage and protection of the Assets. The Assets are VR and AR objects created by the Artists using the Asset Generator as well as stories created by users of the Story Builder.

Asset Generation Sub-System: Inputs: from anywhere it can: Word, Powerpoint, Videos, 3D objects etc. and turns them into interactive objects that can be displayed in AR/VR (HMD or flat screens). Outputs: based on scale, resolution, device attributes and connectivity requirements.

Story Builder Subsystem: Inputs: Environment for creating the story. Target environment can be physical and virtual. Assets to be used in story; Library content and external content (Word, Powerpoint, Videos, 3D objects etc). Output: Story; =Assets inside an environment displayed over a timeline. User Experience element for creation and editing.

CMS Database: Inputs: Manages The Library, Any asset: AR/VR Assets, MS Office files and other 2D files and Videos. Outputs: Assets filtered by license information.

Collaboration Manager Subsystem. Inputs: Stories from the Story Builder, Time/Place (Physical or virtual)/Participant information (contact information, authentication information, local vs. Geographically distributed). During the gathering/meeting gather and redistribute: Participant real time behavior, vector data, and shared real time media, analytics and session recording, and external content (Word, Powerpoint, Videos, 3D objects etc). Output: Story content, allowed participant contributions Included shared files, vector data and real time media; and gathering rules to the participants. Gathering invitation and reminders. Participant story distribution. Analytics and session recording (Where does it go). (Out-of-band access/security criteria).

Device Optimization Service Layer. Inputs: Story content and rules associated with the participant. Outputs: Analytics and session recording. Allowed participant contributions.

Rendering Engine Obfuscation Layer. Inputs: Story content to the participants. Participant real time behavior and movement. Outputs: Frames to the device display. Avatar manipulation

Real-time platform: The RTP This cross-platform engine is written in C++ with selectable DirectX and OpenGL renderers. Currently supported platforms are Windows (PC), iOS (iPhone/iPad), and Mac OS X. On current generation PC hardware, the engine is capable of rendering textured and lit scenes containing approximately 20 million polygons in real time at 30 FPS or higher. 3D wireframe geometry, materials, and lights can be exported from 3DS MAX and Lightwave 3D modeling/animation packages. Textures and 2D UI layouts are imported directly from Photoshop PSD files. Engine features include vertex and pixel shader effects, particle effects for explosions and smoke, cast shadows blended skeletal character animations with weighted skin deformation, collision detection, Lua scripting language of all entities, objects and properties.

### Other Aspects

Each method of this disclosure can be used with virtual reality (VR), augmented reality (AR), and/or mixed reality (MR) technologies. Virtual environments and virtual content may be presented using VR technologies, AR technologies, and/or MR technologies. By way of example, a virtual environment in AR may include one or more digital layers that are superimposed onto a physical (real world environment).

The user of a user device may be a human user, a machine user (e.g., a computer configured by a software program to interact with the user device), or any suitable combination thereof (e.g., a human assisted by a machine, or a machine supervised by a human).

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed. By way of example, machines may include one or more computing device(s), processor(s), controller(s), integrated circuit(s), chip(s), system(s) on a chip, server(s), programmable logic device(s), other circuitry, and/or other suitable means described herein or otherwise known in the art. One or more machines that are configured to perform the methods or operations comprising the steps of any methods described herein are contemplated. Systems that include one or more machines and the one or more non-transitory machine-readable media embodying program instructions that, when executed by the one or more machines, cause the one or more machines to perform or implement operations comprising the steps of any methods described herein are also contemplated. Systems comprising one or more modules that perform, are operable to perform, or adapted to perform different method steps/stages disclosed herein are also contemplated, where the modules are implemented using one or more machines listed herein or other suitable hardware.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Processes described above and shown in the figures include steps that are performed at particular machines. In alternative embodiments, those steps may be performed by other machines (e.g., steps performed by a server may be performed by a user device if possible, and steps performed by the user device may be performed by the server if possible).

When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

1. A method for bandwidth optimization during multi-user meetings that use virtual environments displayed on screens of virtual reality, augmented reality or other user devices, wherein the method comprises:
generating a virtual environment for use by a first user, a second user, and optionally other users;
determining that the first user is permitted to engage in one or more types of action within the virtual environment;
determining that a second user is not permitted to engage in the one or more types of action within the virtual environment;
permitting the first user to engage in the one or more types of action within the virtual environment; and
prohibiting the second user from engaging in the one or more types of action within the virtual environment.

2. The method of claim 1, wherein the one or more types of action includes moving to any position in the virtual environment, and wherein the method comprises:
determining a position in the virtual environment at which the second user is to be located;
setting the position as the location of the second user in the virtual environment;
providing a user device operated by the second user with images of the virtual environment that is in view from the position; and
not allowing the second user to move from the position to any other position in the virtual environment.

3. The method of claim 1, wherein the one or more types of action includes moving to any position in the virtual environment, and wherein the method comprises:
determining a first position from among a first set of one or more predefined positions in the virtual environment at which the second user is to be located;
setting the first position as the location of the second user in the virtual environment during a first period of time;
providing a user device operated by the second user with images of the virtual environment that is in view from the first position;
allowing the second user to move from the first position to a second position in the first set of one or more predefined positions in the virtual environment; and
not allowing the second user to move to any other position in the virtual environment that is not a position in the first set of predefined positions.

4. The method of claim 3, wherein the method comprises:
receiving, from a user, a selection of a group of one or more positions in the virtual environment;
including the selected group of positions as positions in the first set of one or more predefined positions;
excluding, from the first set of one or more predefined positions, other positions in the virtual environment that were not selected by the user; and
storing information about the first set of one or more predefined positions.

5. The method of claim 1, wherein the one or more types of action includes moving to any of all positions in the virtual environment, and wherein the method comprises:
determining that the first user moved from a first position to a second position; and
in response to determining that the first user moved from the first position to the second position, moving the second user from a first predefined position to a second predefined position.

6. The method of claim 1, wherein the virtual environment contains virtual content, wherein the one or more types of action includes interacting with the virtual content other than viewing the virtual content, and wherein the method comprises:
for each user in a second set of users that includes the second user:
providing a user device operated by that user with images of virtual content; and
prohibiting that user from interacting with the virtual content other than viewing the virtual content.

7. The method of claim 1, wherein the one or more types of action includes distributing a predefined type of communication data to other users, and wherein the method comprises:
for each user in a second set of users that includes the second user:
prohibiting that user from distributing the predefined type of communication data to other users.

8. The method of claim 1, wherein the one or more types of action are selected by an administrator of the meeting before the steps of (i) determining that the first user is permitted to engage in the one or more types of action and (iii) determining that a second user is not permitted to engage in the one or more types of action.

9. The method of claim 1, wherein the method comprises:
determining a maximum number of users that are allowed to engage in the one or more types of action within the virtual environment,
wherein determining that the first user is permitted to engage in the one or more types of action within the virtual environment comprises determining that a first number of users determined as being permitted to engage in the one or more types of action within the virtual environment at a first instance in time is less than the maximum number of users, and
wherein determining that the second user is not permitted to engage in the one or more types of action within the virtual environment comprises determining that a second number of users determined as being permitted to engage in the one or more types of action within the virtual environment at a second instance in time after the first instance in time is not less than the maximum number of users.

10. The method of claim 1, wherein the method comprises:
determining that the first user is permitted to engage in the one or more types of action within the virtual environment when the first user is identified by another user as being permitted to engage in the one or more types of action within the virtual environment; and
determining that the second user is not permitted to engage in the one or more types of action within the virtual environment when the second user is not identified by another user as being permitted to engage in the one or more types of action within the virtual environment.

11. The method of claim 1, wherein the method comprises:
determining that the first user is permitted to engage in the one or more types of action within the virtual environment when the first user has a first status value that matches a predefined status value; and
determining that the second user is not permitted to engage in the one or more types of action within the virtual environment when the second user has a second status value that does not match the predefined status value.

12. The method of claim 1, wherein the method comprises:
determining that the first user is permitted to engage in the one or more types of action within the virtual environment when a first user device operated by the first user has a first capability that matches one or more predefined capabilities; and
determining that the second user is not permitted to engage in the one or more types of action within the virtual environment when a second user device operated by the second user has a second capability that does not match the one or more predefined capabilities.

13. The method of claim 1, wherein the method comprises:
determining that the first user is permitted to engage in the one or more types of action within the virtual environment when a first connection speed of a first user device operated by the first user matches or exceeds a predefined connection speed; and
determining that the second user is not permitted to engage in the one or more types of action within the virtual environment when a second connection speed of a second user device operated by the second user does not match or exceed the predefined connection speed.

14. The method of claim 1, wherein the steps of (i) determining that the first user is permitted to engage in the one or more types of action, (ii) determining that the second user is not permitted to engage in the one or more types of action, (iii) permitting the first user to engage in the one or more types of action, and (iv) prohibiting the second user from engaging in the one or more types of action occur during a first time period, and wherein the method comprises:
determining, during a second time period, that the first user is not permitted to engage in the one or more types of action within the virtual environment; and
prohibiting, during the second time period, the first user from engaging in the one or more types of action within the virtual environment.

15. The method of claim 14, wherein the method comprises:
determining, during the first time period, that the first user is permitted to engage in the one or more types of action within the virtual environment when (i) the first user is identified by another user as being permitted to engage in the one or more types of action within the virtual environment, (ii) a status value of the first user matches a predefined status value, (iii) a user device operated by the first user has a capability that matches a predefined capability, or (iv) a connection speed of the user device operated by the first user matches or exceeds a predefined connection speed; and
determining, during the second time period, that the first user is not permitted to engage in the one or more types of action within the virtual environment when (i) the first user is no longer identified by the other user as being permitted to engage in the one or more types of action within the virtual environment, (ii) a new status value of the first user does not match the predefined status value, (iii) the user device operated by the first user no longer has the capability that matches the predefined capability, or (iv) the connection speed of the user device operated by the first user no longer matches or exceeds the predefined connection speed.

16. The method of claim 1, wherein the steps of (i) determining that the first user is permitted to engage in the one or more types of action, (ii) determining that a second user is not permitted to engage in the one or more types of action, (iii) permitting the first user to engage in the one or more types of action, and (iv) prohibiting the second user from engaging in the one or more types of action occur during a first time period, and wherein the method comprises:
determining, during a second time period, that the second user is permitted to engage in the one or more types of action within the virtual environment; and
permitting, during the second time period, the second user to engage in the one or more types of action within the virtual environment.

17. The method of claim 16, wherein determining that the second user is permitted to engage in the one or more types of action within the virtual environment comprises:
determining, during the first time period, that the second user is not permitted to engage in the one or more types of action within the virtual environment when (i) the second user is not identified by another user as being permitted to engage in the one or more types of action within the virtual environment, (ii) a status value of the second user does not match a predefined status value, (iii) a user device operated by the second user does not have a capability that matches a predefined capability, (iv) a connection speed of the user device operated by the second user does not match or exceed a predefined connection speed, or (v) no additional users are permitted to engage in the one or more types of action within the virtual environment when the first user is permitted to engage in the one or more types of action within the virtual environment; and
determining, during the second time period, that the second user is permitted to engage in the one or more types of action within the virtual environment when (i) the second user is identified by the other user as being permitted to engage in the one or more types of action within the virtual environment, (ii) a new status value of the second user matches the predefined status value, (iii) the user device operated by the second user has the capability that matches the predefined capability, (iv) the connection speed of the user device operated by the second user matches or exceeds the predefined connection speed, or (v) the first user is no longer permitted to engage in the one or more types of action within the virtual environment.

18. The method of claim 1, (i) determining that the first user is permitted to engage in the one or more types of action, (ii) determining that a second user is not permitted to engage in the one or more types of action, (iii) permitting the first user to engage in the one or more types of action, and (iv) prohibiting the second user from engaging in the one or more types of action occur during a first time period, and wherein the method comprises:
determining, during a second time period, that the second user is permitted to engage in the one or more types of action within the virtual environment;
determining, during the second time period, that the first user is not permitted to engage in the one or more types of action within the virtual environment;
permitting, during the second time period, the second user to engage in the one or more types of action within the virtual environment; and
prohibiting, during the second time period, the first user from engaging in the one or more types of action within the virtual environment.

19. The method of claim 18, wherein the method comprises:
receiving, during the second time period, a selection of the second user from the first user; and
in response to receiving the selection of the second user during the second time period, determining that the first user is not permitted to engage in the one or more types of action within the virtual environment, and that the second user is permitted to engage in the one or more types of action within the virtual environment.

20. One or more non-transitory machine-readable media embodying program instructions that, when executed by one or more machines, cause the one or more machines to implement the method of claim 1.
